(19) United States
(12) Patent Application Publication
(10) Pub. No.: US 2007/0199763 A1
(43) Pub. Date: Aug. 30, 2007

(54) Rigid axle with integrated spring brackets for use on a vehicle

(76) Inventors: Steffen Henze, Lutherstadt (DE); Klaus Schutz, Esslingen (DE); Kai Tolle, Vellmar (DE); Steffen Weber, Kaufungen (DE)

Correspondence Address: KLAUS J. BACH, 4407 TWIN OAKS DRIVE, MURRYSVILLE, PA, 15668, US

(21) Appl. No.: 11/711,167

(22) Filed: Feb. 26, 2007

Related U.S. Application Data
(63) Continuation-in-part of application No. PCT/EP05/09078, filed on Aug. 23, 2005.

(30) Foreign Application Priority Data
Aug. 27, 2004 (DE) 10 2004 041 427.0

(51) Int. Cl. B60K 17/16; B60B 37/00; F16H 57/02; B60G 9/00

(52) U.S. Cl. 180/378; 180/374; 301/124.1; 74/607; 280/124.156

(57) ABSTRACT

In a rigid drive axle for a vehicle comprising an axle beam provided with a differential housing, at least two tubular axle sections extending in opposite directions from the differential housing and spring support brackets projecting laterally from the axle tube sections, the spring support brackets are integral parts of the axle tube sections facilitating adaptation to various automotive vehicles and forming a relatively low-weight structure which increases the ride comfort and driving safety and also provides for minimal tire wear.

This is a CIP application of pending international application PCT/EP2005/009078 filed Aug. 23, 2005 and claiming the priority of German patent application 10 2004 041 437.0 filed Aug. 27, 2004

### BACKGROUND OF THE INVENTION

The invention relates to a driven rigid axle for a vehicle, comprising an axle beam provided with a differential housing, at least two projecting spring brackets and outer axle end pieces in the form of axle journals.

DE 296 16 257 U1 discloses a pneumatically sprung rigid axle for a vehicle, comprising a axle tube with trailing arms welded thereto. Trailing arms with corresponding socket holes are pushed onto both axle tubes from the two opposite ends, each of which forms an axle journal. The trailing arms are welded along the socket holes to the axle tubes and extend rearwardly beyond the axle tube. The free ends serve as seats for air springs. As a result, however, the trailing arm is subjected to bending stresses. In order to avoid weakening of the trailing arm through by the provision i of the socket holes, the trailing arm must be designed with a relatively large cross-sectional profile. Such strengthening measures contribute detrimentally to the amount of the unsprung mass of a vehicle.

EP 0 881 107 B1 furthermore discloses a driven rigid axle, in which the spring brackets are bolted to the axle beam by way of separate flanges. In this case large bearing and support forces in the area of the assembly joints between the axle beam and the spring brackets results in a large unsprung mass due, among other things, to the large all thickness of the structure.

It is the object of the present invention to provide a driven rigid axle for a motor vehicle, which will serve to increase the ride comfort and driving safety with minimal tire wear while facilitating adaptation to various types of motor vehicles.

### SUMMARY OF THE INVENTION

In a rigid drive axle for a vehicle comprising an axle beam provided with a differential housing, at least two tubular axle sections extending in opposite directions from the differential housing and spring support brackets projecting laterally from the axle tube sections, the spring support brackets are integral parts of the axle tube sections facilitating adaptation to various automotive vehicles and forming a relatively low-weight structure which increases the ride comfort and driving safety and also provides for minimal tire wear.

Such driven rigid axles are primarily used in commercial vehicles. The components of these axles, that is, the differential housing and/or the drive housing, the two spring brackets with the axle tube sections and the two axle end sections, are assembled according to the vehicle performance, track width and admissible axle load and are generally in each case welded to one another at the end faces thereof. An individual spring bracket comprises an axle tube section and a cantilever arm. The axle tube section forms the direct connection between the differential housing and the respective axle end piece. The cantilever arm forms the carrier for the spring element and any shock absorber. An anti-roll bar may also be articulated thereon.

Where it is intended, for example, to produce an axle having a track width greater than the standard track width, spring brackets are used with elongated axle tube sections. Instead of longer axle tube sections, a larger differential housing can be used for the same frame width and greater vehicle performance. In vehicles with a low ground clearance and smaller wheel sizes it is also possible to use simple spring brackets, in which the spring seating surfaces have another position in relation to the axle beam.

Despite the additional function as spring element carrier, the axle beam is of a modular construction, which permits a number of axle beam variants.

Integrating the spring brackets into the axle tube means that the design of the latter can be adapted more precisely to the prevailing load forces. Among other things, the axle tube cross sections in the proximity of the differential can be enlarged in order to increase the moment of resistance. Moreover, inside the spring bracket the transitions between the axle tube section and the cantilever arm can be formed in such a way that the peak stresses in the material, which are common at these points, are greatly reduced. Overall space is also gained because no fastening elements are needed between the axle tube and the spring seat.

All of these measures combined serve on one hand to reduce the mass of the axle without reducing its load-bearing capability and on the other to save costs incurred in production, inventory, assembly and maintenance.

The smaller weight also results in a lower unsprung axle mass and hence the tendency of the rigid axle to axle tromping. This improves the road-holding and hence the driving safety of the vehicle and also the ride comfort It also has a positive effect on the service life of the tires.

The invention will be described below in greater detail on the basis of exemplary embodiments with reference to the accompanying drawings:

### BRIEF DESCRIPTION OF THE DRAWINGS

FIG. 1: shows an axle beam with integrated spring brackets of sheet metal construction;

FIG. 2: is a side view of the axle beam shown in FIG. 1;

FIG. 3: shows an axle beam essentially as shown in FIG. 1, but of cast or forged construction; and

FIG. 4: is a side view of the axle beam of FIG. 3.

### DESCRIPTION OF PREFERRED EMBODIMENTS

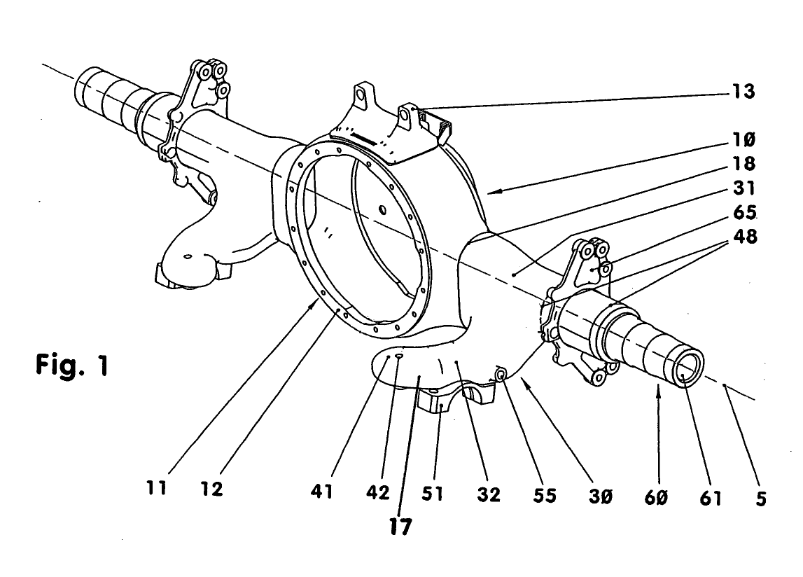

FIGS. 1 to 4 show examples of two different axle beams (10, 110), which may in each case be driven rigid axles of a commercial vehicle. Such an axle may also be a steered axle.

The axle beam (10) as shown in FIG. 1 comprises a center structure (12) including a differential housing (11), opposite axle tube sections 31 with spring brackets (30) and two axle journals (61) forming the outer axle beam end sections (60).

The differential housing (11), may be formed from sheet metal and form the center part of the axle beam (10). As shown in the figures it is provided with. A support bracket (13), which may be forged, for example. The axle beam (10) is supported via a wishbone (not shown) on the vehicle frame by way of this support bracket (13). At either side, the differential housing (10) has a large opening of rectangular cross section, for example. The corners of these cross sections are rounded. At least 60% of the vertical portion of these virtually oval cross sections is situated below a horizontal plane (8) lying on the axle center line (5). The area of the axle beam (10), which is subjected to tensile stress, is thereby situated at a greater distance from the neutral line—in this case the axle center line (5), for example—than the correspondingly opposite zone subjected to compressive stress.

The planar end faces of these openings form a junction (18).

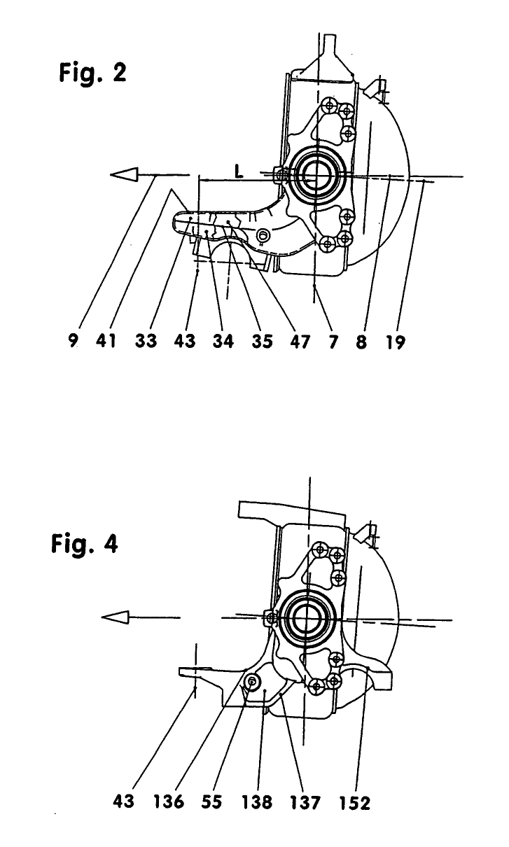

The spring bracket structures (30) adjoin the differential housing (11) on both sides. Each spring bracket structure (30) consists, for example, of a lower and an upper shell (33, 34) made of sheet metal, cf. FIG. 2. The two shells (33, 34) are welded to one another and enclose a cavity (17). In addition to an axle tube section (31) situated immediately between the housing (13) and the axle end section (60), the individual spring brackets (30) comprise a forwardly or rearwardly projecting cantilever arm (32) which, for example, extends at least approximately parallel to a vertical plane, extending in the vehicle longitudinal direction. Each cantilever arm (32) has an elliptical to oval closed cross-section in a direction perpendicular to its longitudinal extent and which taper away from the axle tube section (31). The taper is continuous with no abrupt cross-section steps, but is as a rule not linear. The sheet metal wall thickness may also vary.

In the area of the free end of each individual spring bracket (30) is a hole (42), via which the spring element is fixed. This hole (42) is situated at the center of the spring seating surface (41), which at least in some areas is a planar surface. In a normal vehicle position said surface is oriented at least approximately parallel to the road surface. In contrast to this, the center line (19) of the differential housing (10) extending in the longitudinal direction of the vehicle is inclined by 3 degrees, for example. The center line (19) rises in the direction of travel.

Measured in the longitudinal direction of the vehicle between the vertical plane (7) extending through the axle center line (5) and the center line (43) of the fitting hole (42), via which the respective spring element is fixed, the projecting length (L) of the individual spring bracket (30) is at least half the length of the minimum housing diameter. The height of the spring seating surface (41) is generally at least 15% of the housing diameter below the horizontal plane (8) defined by the axle axis (5) and above the lower edge of the housing (12).

A bearing bracket (51) in the form of a clamp for the articulation of an axle-guiding lower suspension link is shown below the free end of the individual spring bracket (30).

Where a tubular rolling bellows is used as a spring, the roll piston is fixed on the spring seating surfaces (41) of the spring brackets (30). If a corrugated bellows is used, for example, and if a mechanical spring is used, the bellows is seated by way of a plate on the spring seating surface (41).

Towards the axle end section (60), the axle tube section (31) of the individual spring bracket (30) terminates in an annular cross section. There, the axle end piece (60) is fixed by friction welding, for example. The annular junction (48) lies with its geometric center on the axle beam axis (5). It is moreover oriented perpendicular to the axle center line (5).

In the exemplary embodiment, the axle end piece (60) is a regular tubular, multiple-stepped axle journal (61).

A brake anchor plate flange (65) is fixed, for example by welding, on each axle tube section (31). The individual brake anchor plate flange (65) is oriented perpendicular to the axle center line (5). The holes for fixing the brake lining carrier (not shown) and the brake caliper are generally situated behind the vertical plane (7) defined by the axle axis (5), cf. FIG. 2. According to FIG. 1 the junction (48)—represented by a dashed line—may also lie behind the brake anchor plate flange (65).

In the variant according to FIGS. 1 and 2, all axle parts, including the axle journals (61), form a common cavity which, possibly partially separated—below the drive half-shafts—by baffle walls, constitute a reservoir for lubricant. The cantilever arms (32) of the spring bracket (30) contribute to the reservoir space and serve also to significantly increase the lubricant cooling axle surface.

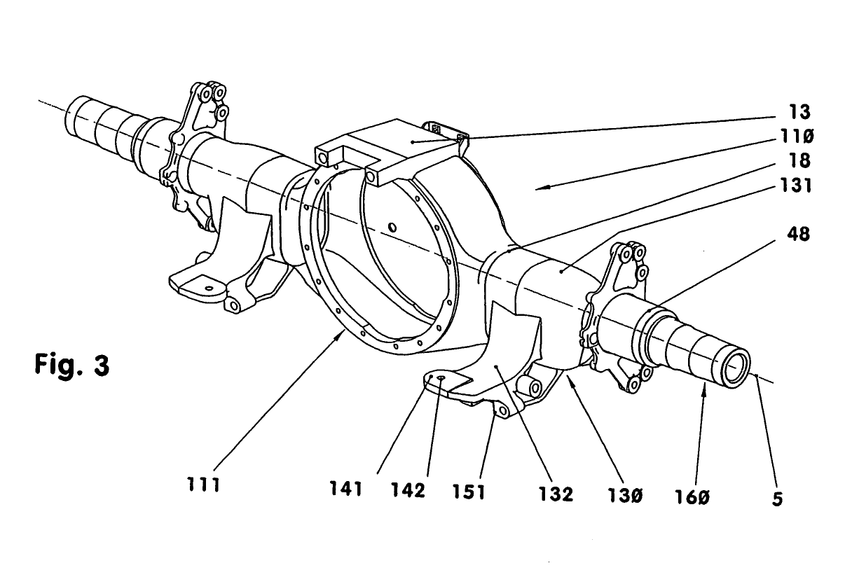

FIGS. 3 and 4 show an axle beam (110), in which at least the spring brackets (130) are embodied as castings or forgings. Here too, the individual, one-piece spring bracket (130) comprises a largely tubular axle tube section (131) and a cantilever arm (132) of lattice structure type, for example. Castings and forgings may, if necessary, be combined with one another within the axle beam (110).

As in the variant in FIGS. 1 and 2, the individual centroids of the wall cross sections of the axle tube section (131) here too lie below the axle center line (5). Viewed in three dimensions, these cross sections in front of the brake anchor plate flange (65) merge from an oval shape, for example, into an annular shape. In the annular cross-sections, the centroids of the cross-sections lie on the axle center line (5).

The individual cantilever arm (132) of the spring bracket (130) is formed as a bent I-shaped member. The I-shaped member comprises an upper, flat lunate flange (136), largely subjected to tensile stresses, a comparable lower flange (137) more subjected to compressive stresses, and at least one central web (138), which unites the two flanges (136, 137), at least in sections. The upper flange (136) merges virtually tangentially into the forward-oriented outer face of the axle tube section (131). The lower flange (137) rests, for example at an angle of 45 degrees, on the underside of the axle tube section (131). The flanges (136, 137) and the web (138) additionally act as cooling fins for the lubricant present in the axle beam cavity.

At the point where the upper flange (136) and the lower flange (137) meet, a bearing bracket (151) is formed on for the articulation of the wheel-guiding suspension links. A further bearing bracket (152) is situated on the rear side of the axle tube section (131), for example, cf. FIG. 4, where an anti-roll bar is generally supported.

A plane surface (141) to support a spring element is formed at the free end of the respective cantilever arm (132). As in the variant previously described, a hole (142) is situated in the area of the center of this face (141).

In the case of asymmetrical axle beams a spacing piece is, if necessary, fixed, for example by welding, on at least one side of the vessel, between the vessel and the spring bracket. It is also possible to design the spring brackets of an axle asymmetrically with one another. They will then be curved to different degrees, for example in a horizontal plane.

In order to join the individual, prefabricated or finished axle beam parts together with as little distortion as possible, welding methods such as laser, pressure or plasma arc welding can be used.

What is claimed is:

1. A rigid drive axle for a motor vehicle comprising an axle beam (10, 110) including a differential housing (11, 111), opposite axle tube sections (31, 131) extending from the differential housing (11, 11) at least two projecting spring support brackets (30, 130) projecting from the axle tube sections (31, 131) and outer axle end sections in the form of axle journals (61), wheel carrier and axle guide structures, said spring support brackets being integral parts of said axle tube sections (31,131).

2. The rigid axle as claimed in claim 1, wherein there is a junction (18) between said differential housing (11) and said axle tube sections (31, 131) which has a cross-sectional area of at least 1.7 times the cross-sectional area of the junction (48) between said axle tube sections (31, 131) and the respective outer axle end section (60, 160).

3. The rigid axle as claimed in claim 1, wherein measured in the longitudinal direction of the vehicle between a vertical plane (7) extending through an axle center line (5) and a center line (43) of a fitting hole (42), used for fixing a respective spring element, the projecting length (L) of the individual spring support bracket (30, 130) is at least half the length of the minimum housing diameter.

4. The rigid axle as claimed in claim 1, wherein said junction (18, 48) is planar.

5. The rigid axle as claimed in claim 1, wherein the junction (18, 48) is oriented parallel to a vertical longitudinal center plane of the vehicle.

6. The rigid axle as claimed in claim 1, wherein the end faces of adjacent axle tube sections are equal in cross-section.

7. The rigid axle as claimed in claim 6, wherein the opposing end faces of adjacent axle beam sections are joined by friction welding.

8. The rigid axle as claimed in claim 1, wherein the individual spring support bracket (30) is a hollow body.

9. The rigid axle as claimed in claim 8, wherein the differential housing (11) and the spring bracket (30) enclose a continuous cavity (17, 47).

10. The rigid axle as claimed in claim 1, wherein in the center area between a spring seating surface (41) of the spring support bracket and the axle tube section (31) the individual spring bracket (30) is a hollow structure.
